(19) United States
(12) Patent Application Publication
(10) Pub. No.: US 2023/0100471 A1
(43) Pub. Date: Mar. 30, 2023

(54) END-TO-END NETWORK AND APPLICATION VISIBILITY CORRELATION LEVERAGING INTEGRATED INTER-SYSTEM MESSAGING

(71) Applicant: Cisco Technology, Inc., San Jose, CA (US)

(72) Inventors: Madhuvanthi Cheyyar Rajasekaran, Santa Clara, CA (US); Walter Theodore Hulick, JR., Pearland, TX (US); David John Zacks, Vancouver (CA); Anusha Maltesh, Milpitas, CA (US); Krishma Harendra Kapadia, San Jose, CA (US)

(21) Appl. No.: 17/488,403

(22) Filed: Sep. 29, 2021

(51) Int. Cl. H04L 12/26; H04L 12/24

(52) U.S. Cl. CPC H04L 43/045; H04L 43/14; H04L 43/06; H04L 41/22; H04L 41/5009

(57) ABSTRACT

In one embodiment, an agent process performs performance monitoring according to either a network performance monitoring platform or an application performance monitoring platform. The agent process exchanges a request message with a remote agent process (performing performance monitoring according to the opposing platform), where the request message comprises a transaction identifier and a requested action. The agent process also exchanges, in response to the request message, a response message with the remote agent process, wherein the response message comprises an acknowledgment of the transaction identifier and the requested action. The agent process shares first performance monitoring platform information along with the transaction identifier, where the remote agent process shares second performance monitoring platform information along with the transaction identifier, such that the sharing causes explicit correlation of the first information and the second information based on the transaction identifier.

### TECHNICAL FIELD

The present disclosure relates generally to computer systems, and, more particularly, to end-to-end (E2E) network and application visibility correlation leveraging integrated inter-system messaging.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

As an example, user experience can be evaluated based on multiple criteria, and every second (or even micro-second) counts. How well an application is performing or how good is the network connectivity makes all the difference in the world. Today, there are many tools that monitor applications regardless of where they are hosted, be it in on premises (“on-prem”) or on the Cloud. There are also tools that provide insight into network conditions, such as whether a cloud service is experiencing any downtime, if the network is experiencing a sudden high volume of users, etc. However, traditionally there is limited correlation between the different types of monitoring systems, and at best, any correlation is merely implicit and convoluted.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of observability agent communication;

FIG. 5A illustrates an example of a request-response exchange for end-to-end (E2E) network and application visibility correlation leveraging integrated inter-system messaging;

FIG. 5B illustrates another example of a request-response exchange for E2E network and application visibility correlation leveraging integrated inter-system messaging;

FIG. 6 illustrates an example of a E2E network and application visibility correlation leveraging integrated inter-system messaging;

FIG. 7 illustrates an example simplified procedure for E2E network and application visibility correlation leveraging integrated inter-system messaging in accordance with one or more embodiments described herein, particularly from the perspective of an agent; and

FIG. 8 illustrates an example simplified procedure for E2E network and application visibility correlation leveraging integrated inter-system messaging in accordance with one or more embodiments described herein, particularly from the perspective of a server.

### DESCRIPTION OF EXAMPLE EMBODIMENTS

### Overview

According to one or more embodiments of the disclosure, an illustrative method herein may comprise: performing, by an agent process, performance monitoring according to a first performance monitoring platform, wherein the first performance monitoring platform is one of either a network performance monitoring platform or an application performance monitoring platform; exchanging, by the agent process, a request message with a remote agent process that is performing performance monitoring according to a second performance monitoring platform, wherein the second performance monitoring platform is one of either the network performance monitoring platform or the application performance monitoring platform that is not the first performance monitoring platform, wherein the request message comprises a transaction identifier and a requested action; exchanging, by the agent process and in response to the request message, a response message with the remote agent process, wherein the response message comprises an acknowledgment of the transaction identifier and the requested action; and sharing, by the agent process and based on the requested action, first information associated with the performance monitoring according to the first performance monitoring platform along with the transaction identifier, wherein the remote agent process is configured to share second information associated with the performance monitoring according to the second performance monitoring platform along with the transaction identifier and based on the requested action, wherein sharing causes explicit correlation of the first information and the second information based on the transaction identifier.

According to one or more additional embodiments of the disclosure, another illustrative method herein may comprise: receiving, at a server, network performance monitoring information from a network agent process configured to perform performance monitoring according to a network performance monitoring platform, the network performance monitoring information having a transaction identifier; receiving, at the server, application performance monitoring information from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action; correlating, by the server, the network performance monitoring information and the application performance monitoring information into correlated information explicitly based on the transaction identifier; and providing, by the server, the correlated information as an integration of the network performance monitoring information and the application performance monitoring information.

According to one or more further embodiments of the disclosure, an illustrative system herein may comprise: a server; a network agent process configured to perform performance monitoring according to a network performance monitoring platform; and an application agent process configured to perform performance monitoring according to an application performance monitoring platform; wherein the network agent process and application agent process are configured to exchange a request message comprising a transaction identifier and a requested action and, in response to the request message, to exchange a response message comprising an acknowledgment of the transaction identifier and the requested action; wherein the network agent process is further configured to share network performance monitoring information to the server along with the transaction identifier and based on the requested action, and wherein the application agent process is further configured to share application performance monitoring information to the server along with the transaction identifier and based on the requested action; wherein the server explicitly correlates the network performance monitoring information and the application performance monitoring information based on the transaction identifier into correlated information.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

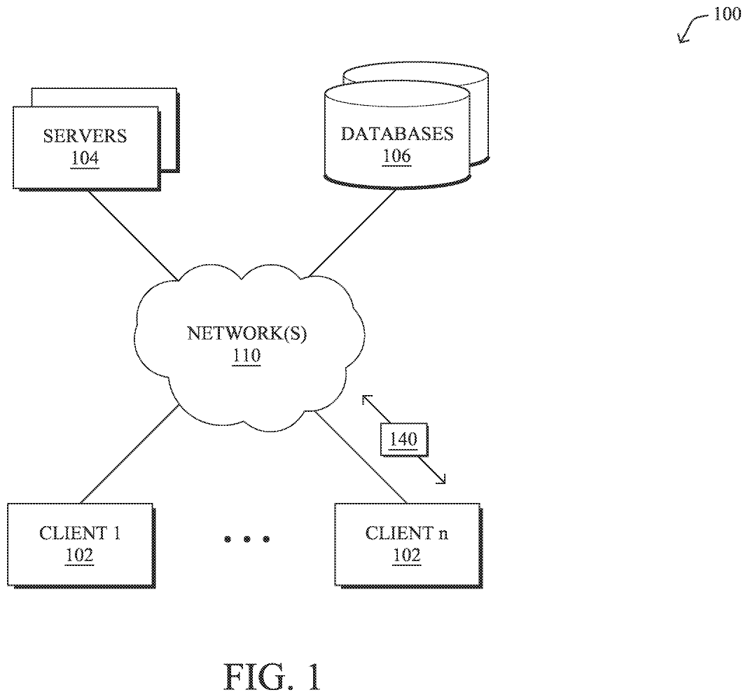

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

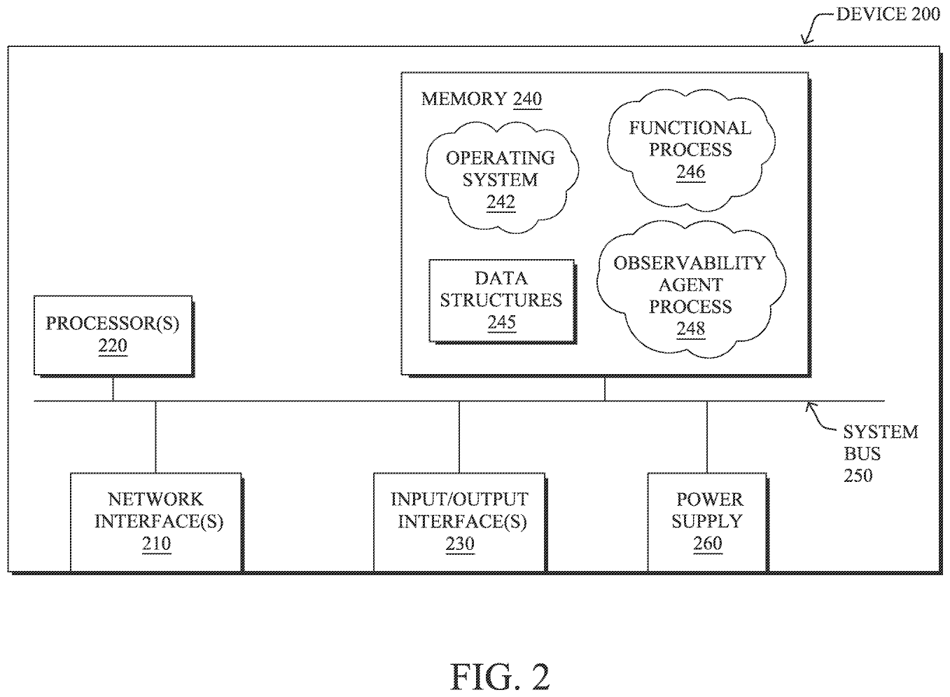

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “observability agent” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

—Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

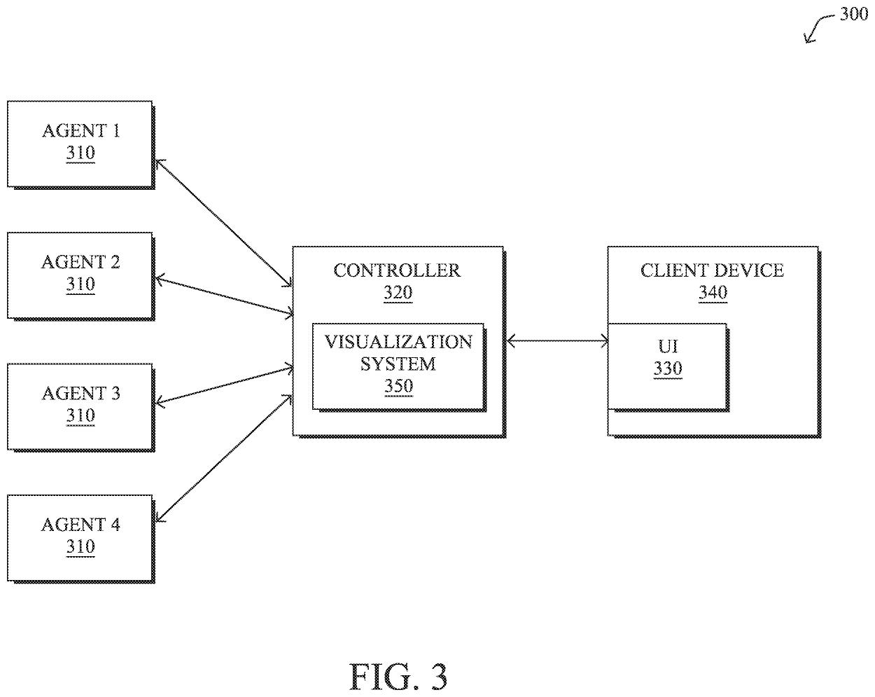

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance 320 may be hosted remotely by a provider of the observability intelligence platform 300. In an illustrative on-premises (On-Prem) implementation, a controller instance 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

—End-to-End Network and Application Correlated Visibility—

As noted above, there are many tools that monitor applications regardless of where they are hosted, be it in on premises (“on-prem”) or on the Cloud. For instance, such specific monitoring for applications is generally referred to as “application performance monitoring” or “APM”, and is typically based on application agents that instrument application behavior (e.g., based on specific transactions, as described above) by monitoring application behavior at various locations throughout the network. Also, there tools that provide insight into network conditions, such as whether a cloud service is experiencing any downtime, if the network is experiencing a sudden high volume of users, etc. Such specific monitoring for networks is generally referred to as “network performance monitoring” or “NPM”, and is typically based on network agents that perform various testing throughout the network (e.g., based on synthetic traffic sent from end-points, servers, and so on, as described above) to determine network topologies and/or performance at various locations throughout the network.

As also noted above, traditional techniques lack the ability to tie the application performance to the network conditions. For example, users and/or admins may like to determine whether an application is impacted when there is an anomaly in the network, and if so, by how much. Today's application and network monitoring systems, however, are separate and disjoint, and providing an integrated view is a complex problem to solve.

The techniques herein, therefore, provide end-to-end (E2E) network and application visibility correlation leveraging integrated inter-system messaging. In particular, the techniques herein correlate application performance with network conditions with an integrated messaging solution that combines the application and networks metrics obtained from any application and network monitoring tool, for example the data obtained from APM agents (application data) and NPM agents (network data). That is, the techniques herein provide a complete end-to-end picture between what happens on the network and what happens inside the application, specifically through the use of a bidirectional messaging system that allows for an inter-system application and networking co-ordination and correlation for monitoring and measurement. Notably, the techniques, as described in greater detail below, provide the correlated visibility in real time, with no additional overhead, enabling rich sharing of bidirectional metrics between application and network agents, while using in-band messaging.

Operationally, the techniques herein are based on integrating an application performance management (APM) platform and a network performance management (NPM) platform. As described above, an “observability intelligence platform” 300 has been detailed generally to include either type of operation (application observation and/or network observation). However, in current implementations, the two platforms typically operate independently, where the operation of the respective agents correspond to one of either APM operations (e.g., APM agents instrumenting applications) or NPM operations (e.g., NPM agents synthetically testing the network).

As an example, the techniques herein may use the AppDynamics® APM platform (available from Cisco Systems, Inc., of San Jose, Calif.) as the platform to provide application metrics, and the ThousandEyes® NPM platform (also available from Cisco Systems, Inc.) as the platform to provide any network-level performance metrics. However, the present disclosure is not bound to these two specific platforms, and would apply to any application and network monitoring tool that can provide application and network performance metrics, accordingly.

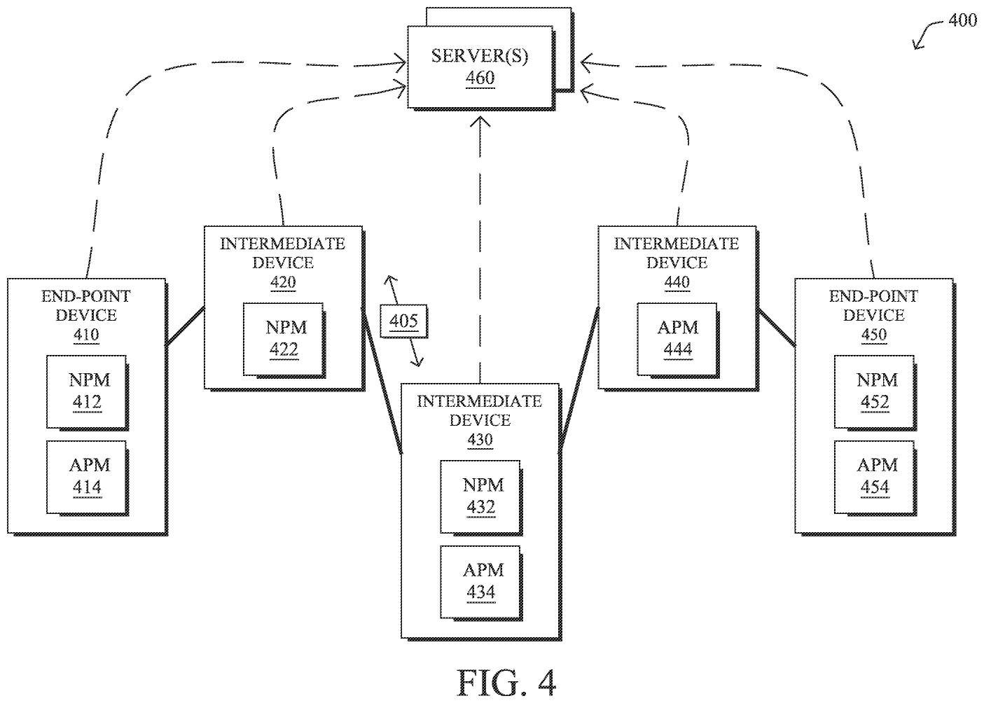

In particular, with reference to observability network environment 400 of FIG. 4, packets (or other data structures) 405 may be communicated between an end-point device 410 through one or more intermediate devices (e.g., 420, 430, and 440), such as routers, switches, firewalls, load-balancers, proxies, etc., and another end-point device 450. End-point devices may be user devices, workstations, internet of things (IoT) devices, servers, web servers, databases, and so on. According to the observability environment, one or more of the devices may have either or both of an NPM agent and/or an APM agent. For example, as shown, end-point device 410 has both an NPM agent 412 and APM agent 414, intermediate device 420 has only an NPM agent 422, intermediate device 430 has both an NPM agent 432 and APM agent 434, intermediate device 440 has only an APM agent 444, and end-point device 450 has both an NPM agent 452 and APM agent 454. Note that any arrangement of agents may be used in accordance with the techniques herein, and the view shown is merely an example implementation.

Additionally, each of the agents, as described above, may communicate with one or more servers 460, for example, a singular server for overall observability, or independent servers for APM and NPM functionality, which may or may not be in further communication and coordination with each other. (In other words, the techniques described below may be based on coordination of information through the NPM and APM agents, or through an NPM and APM server receiving information from respective NPM and APM agents, accordingly.)

As a recap of the APM and NPM (monitoring) systems, the APM platform may report application performance using several instrumentation points, such as, for example:
At the browser level—e.g., using End-User Monitoring (EUM);
At the application itself—e.g., using APM agents;
At the IoT level—e.g., using IoT Remote-user Monitoring (RUM);
At the device level—e.g., using Mobile Remote-user Monitoring (RUM);
At the operating system (OS) and container level—e.g., using Machine Agents;
Etc.
   The primary focus of the APM platform is generally based on observing and obtaining such metrics and information as: the Average Response Time (ART), business transactions, error rate, transaction tracing, and so on.

Conversely, the NPM platform may report network-level monitoring and performance metrics using various instrumentation points, such as, for example:
At the browser level—e.g., using End-user Monitoring;
At the endpoint—e.g., using Endpoint Agents and Synthetic measurements;
At the network level—e.g., using ICMP;
At the router level—e.g., using SNMP/etc.;
Etc.
   Also, the primary focus of the NPM platform is generally based on observing and obtaining such metrics and information as: the internet path, the network connectivity and response times, the network uptime, network throughput, and so on.

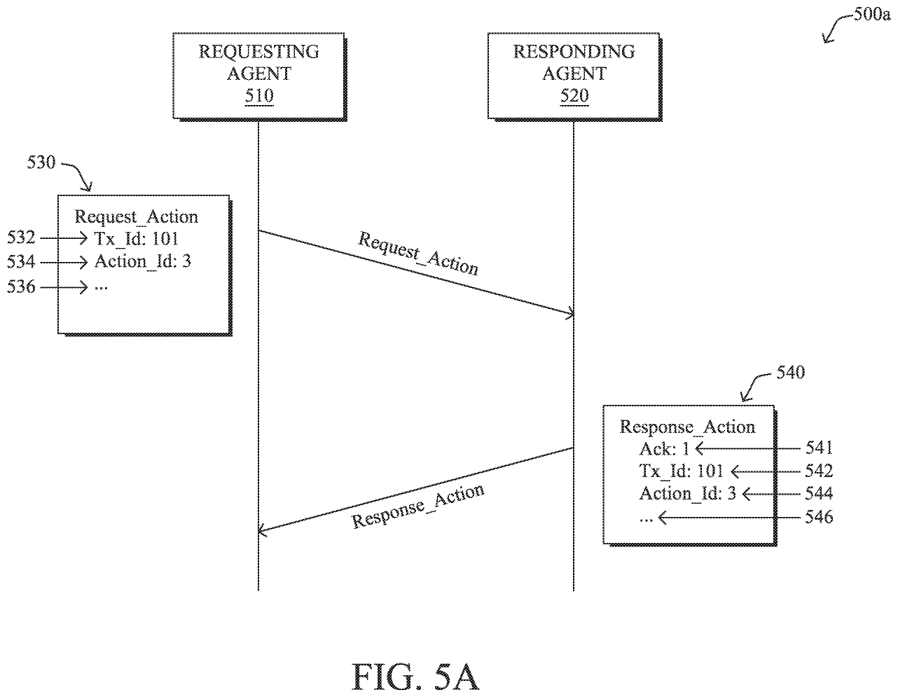

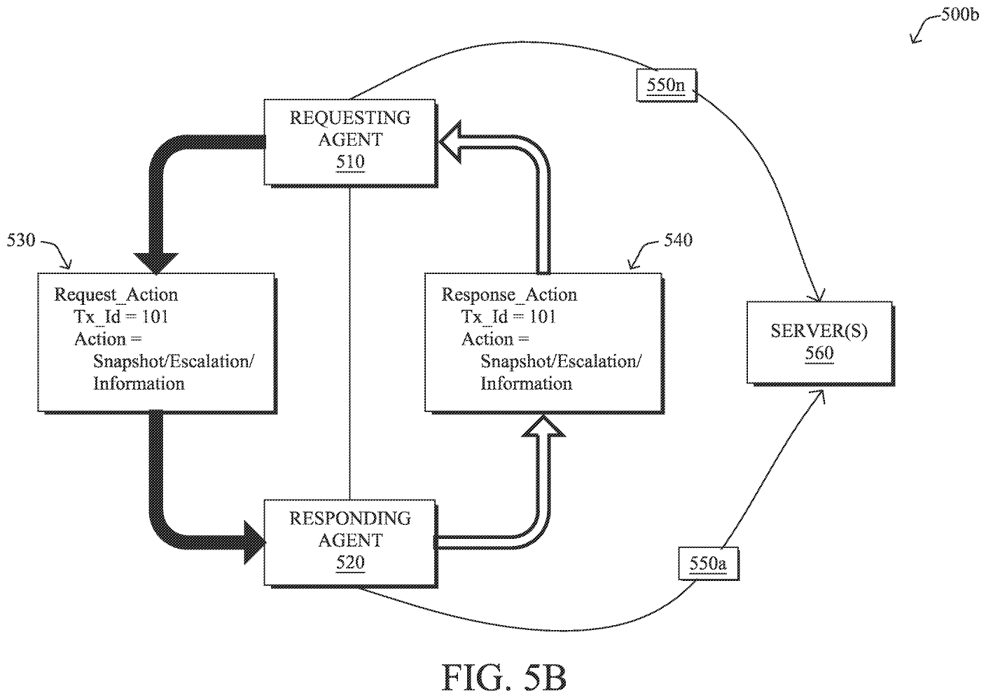

In order to correlate the data between the APM tools and NPM tools, the embodiments herein provide specific integration parameters that can be used to derive empirical data from application and network performance metrics. According to the techniques of the present disclosure, therefore, a request-response paradigm is described herein, where agents of the different systems may communicate with each other to share “transaction identifiers/IDs” with each other in order to allow for correlation of their associated data, accordingly. In particular, and with reference to message exchange 500a of FIG. 5A, in order to have the full transaction visibility between the APM tool and NPM tool, a requesting agent 510 and a responding agent 520 would share transaction instance correlation through the explicit passing of the transaction ID.

For instance, a request action message 530 (“request 530”) may comprise a transaction ID used by the requesting agent 510 for a particular transaction being monitored (e.g., an event, a process, an application, a test, etc.), as well as an indicated action 534, and optionally other information 536. Indicated actions 534, for example, may be either detailed instructions or a shorter code/ID-based field, such as, e.g., “action_id=3” as shown. (The actions themselves are described in greater detail below.)

The request 530 is transmitted by the requesting agent 510 to the responding agent 520, which receives the request and prepares and returns a response action message 540 (“response 540”). The response itself may comprise an acknowledgment 541, as well as a return of a transaction ID 542, the action 544, and optionally other information 546. The response 540 may then be returned/sent to the requesting agent 510.

Various triggers may cause the initial request herein, such as various NPM platform testing triggers (e.g., periodic, on-demand, in response to an anomaly, in response to an error, in response to poor performance, etc.), as well as being user-triggered (e.g., selecting a correlated test), or triggered based on user sentiment implicitly (e.g., a user indicating poor application performance, such as “my video conference experience is poor right now”). Such triggers may also be based on past experience, such as by flagging a particular experience in the past as good or bad (e.g., one out of five stars for a rating on a conferencing application quality), in which case the application data and network data that was observed in the past may be specifically correlated (e.g., the past 5, 10, 30, 60 minutes of both APM and NPM data would then be correlated for post real time analysis). Other triggers for the requested action and correlation may be used herein, and those mentioned are merely examples for illustration.

Note that the responding agent 520 may read and store the received transaction ID 532 inserted into the request 530, and the requesting agent 510 may also read and store the returned transaction ID 542 inserted into the response 540. In one embodiment, the transaction IDs 532/542 are the same for matching correlation (i.e., the responding agent uses the initial ID from the requesting agent), such as “101” and “101”, where in another embodiment, the transaction IDs are different (i.e., the requesting agent has its own ID, such as “101”, and the responding agent has its own ID, such as “B75G”), and the two different IDs are interrelated for later correlation based on the IDs (e.g., “101” and “B75G” are referring to the same transaction, but in different monitoring platforms).

Notably, the integration focus of the techniques herein may be based on an example implementation, where application performance may be obtained through a runtime APM Agent (e.g., on an HTTP Server, such as APM agent 454 on end-point 450 above), and network performance may be obtained through an endpoint agent (e.g., on a desktop web browser, such as NPM agent 412 end-point 410 above) sending a synthetic HTTP server test (e.g., a message 405) to the HTTP server (e.g., upon instruction from a command console/controller that creates and dispatches the test to the end-point, such as server 460). In one specific embodiment herein, therefore, the techniques herein “piggyback” on the synthetic HTTP messages of the NPM tool (e.g., within a header field or otherwise within the HTTP messages). Namely, this illustrative embodiment establishes a new protocol on top of (in-band with) the Request and Response packets of the synthetic NPM messages, such that there is a “full duplex” in-band communication between the NPM agents and APM agents. In particular, this embodiment includes the ability for the NPM agent to “request” an action from the APM agent using HTTP synthetic test requests, and for the APM agent to perform the action based on the request received and to respond with the HTTP Response packets, accordingly, and based on the exchange shown above in FIG. 5A.

Note further that while in this specific embodiment above the requesting agent 510 is an NPM agent and the responding agent 520 is the APM agent, other directions may be used herein. That is, while the embodiment above allows for in-band messaging using the already implemented HTTP synthetic test messages (request/response messages), other types of message exchanges (e.g., in-band or out-of-band) may also be used to allow the APM agent to be the requesting agent 510 to an NPM agent as the responding agent 520. Additionally, the responding agent may, in certain embodiments, initiate the correlation request, or may add to it. That is, for example, where the original request message 530 may or may not have any action to perform, the responding agent 520 may insert into the response message 540 an action for the requesting agent 510 to perform, singularly or in addition to the action requested of the responding agent as well. (In this scenario, the requesting agent 510 may perform the action and share the results with a server, or may return another message back to the responding agent 520 for local processing.)

The collaborative process described above will thus allow the correlation of the transaction instances between the two conventionally disparate performance monitoring products. In particular, as shown in FIG. 5B, an alternative view of the communication exchange 500b is shown, where requesting agent 510 and responding agent 520 pass requests 530 and responses 540, but then further provide their own observation data and information to one or more servers 560, along with the necessary transaction IDs to allow the server(s) to align the NPM data (e.g., 550n) and APM data (e.g., 550a) in the time domain (i.e., a snapshot of the network and the application at the same time for a full picture of the transaction instance at that given time). That is, the data messages 550n and 550a may comprise the observed information for the respective performance observation platforms (e.g., NPM and APM), but may further include the transaction ID for correlation, according to the techniques herein (e.g., the shared transaction ID, or both the locally used ID and the remotely provided ID by the opposing agent, as noted above), such that the server(s) can correlate the two sets of received data appropriately.

To better understand the correlation process in real time, example actions herein, typically at the request of the NPM tool (i.e., NPM agent is the requesting agent 510), may include an “action” header in the request message that the APM tool/agent would see inbound (e.g., to the Application Server). The request messages contain “verbs and adjectives” that would be understood by the APM agent, and each action may have a unique “Action ID” as noted above. In one embodiment, each response to an action would also contain the “Action ID” along with the transaction ID so that the specific action of the request/response would also be correlated.

As examples, actions from the requesting agent to the responding agent may include such things as:
1) A Snapshot Request— APM platforms may takes “Snapshots” (periodically or randomly), which are complete instances of the Transaction. Due to overhead, this is limited in number. Snapshots are key to troubleshooting with APM platforms and customers spend a lot of time looking at them. However, they are “hit or miss”. The techniques herein may advantageously use the NPM platform to greatly increase the ability to capture the “right” snapshots by using logic at the synthetic network testing level to know when to request a snapshot, such as based on network conditions, previous results, etc.
2) An Escalation Request— APM platforms have certain functions which have more overhead but produce more granular data/metrics/forensics. Normally these are turned on/off manually from a user interface (UI). However, the NPM platform may specifically request these functions be turned on/off on-demand based on certain factors, such as network conditions, previous results, and so on.
3) An Information Request— APM platforms have information about the Application that the NPM agent could use to make the synthetic experience “richer” in terms of the product. For instance, a request could be made, and the response would be read by the synthetics NPM agent, or correlated by the appropriate server(s). Examples of information requests might include such things as:
   a. What is the Transaction Name?
   b. What is the Transaction Type? (Banking, etc.)
   c. What does the Transaction Topology look like?
   d. What is the Application Name?
   e. What is the Response Time at the Application?
   f. What is the code/call stack for this Transaction?
   g. Did any Errors occur?
   h. Are you in a container?
   i. Etc.
Conversely, Example information request actions from APM agents to NPM agents, might include such things as:
   j. What is the hop path/route between the user and this Application?
   k. What is the originating IP address?
   l. Etc.

For real time information sharing, in particular, certain information may be shared by the APM agent and/or the NPM agent, and inserted directly into the respective request/response message. That is, as noted above, the information may be sent to the server(s) independently (e.g., messages 550n and 550a), or else the information may be shared directly between the agents for localized processing in the request message 530 and/or response message 540, accordingly. Note that according to the techniques herein, the responding device “shares” its respective information/IDs to the server(s), regardless of whether the responding agent returns the information/IDs directly to the requesting agent which then passes it to the server, or else by directly sharing it to the server(s) itself. In this sense, “correlation” of the NPM and APM information may be “caused” for the server either through the action of the requesting agent, or through action of the server, to combine the appropriate information, accordingly.

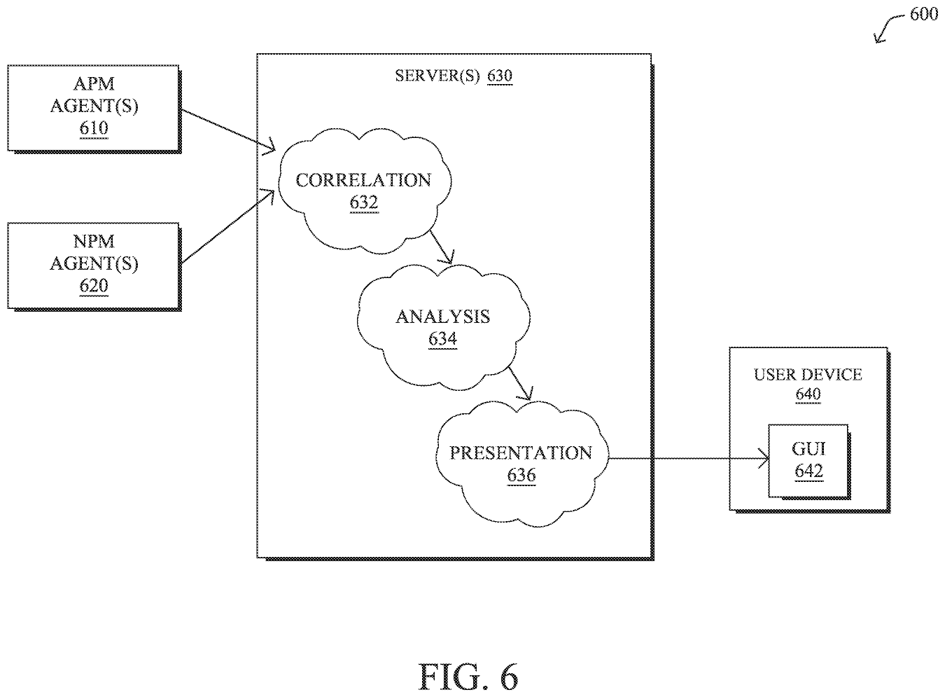

The correlation of the NPM agent data (what the NPM agent sees on the network) and the APM agent data (what the APM agent sees in the application) may then be used for various actions/reactions, analysis, and general presentation for administrative purposes, as may be appreciated by those skilled in the art. For instance, as shown in the environment 600 of FIG. 6, the APM agent(s) 610 and NPM agent(s) 620 share their information with the server(s) 630 (e.g., directly, or by passing the information through the other opposing agent, as noted above). The server then correlates the information based on the transaction IDs (correlation process 632), and then may perform various analytical actions (analysis process 634) before creating one or more presentations of the information (presentation process 636), such as various graphical displays, charts, graphs, tables, hotspots, mappings, alerts, mitigation actions, recommended actions, and so on. This may be sent to (or accessed by) one or more user devices 640 for display on a graphical user interface 642.

For example, the techniques herein may be configured to provide an integrated visual view of transaction data in the form of dashboards to track and monitor unified end-to-end visibility post real time for analysis. For instance, an NPM dashboard (GUI) may now include transaction names, application average response time (ART), transaction call stack, application error counts, and other application information not previously exposed to NPM platforms. Various links may also be provided within the NPM dashboard to allow a user/admin to click the link to “launch in context” to the APM dashboard showing the associated data there, such as the transaction topology, business intelligence dashboard, EUM Analytics, an APM snapshot, and so on. Conversely, the APM dashboard (GUI) may now include such NPM-based information, such as number of hops between the user and the application, network average response time (ART), and other network information not previously exposed to APM platforms. Additionally, various links may also be provided within the APM dashboard to allow a user/admin to click the link to “launch in context” to the NPM Dashboard showing the associated data there, such as the network topology for the transaction, associated network metrics, and so on.

In addition, there are numerous application programming interfaces (APIs) that can be shared between the NPM platform and APM platform to review metrics (e.g., correlating based on the Transaction IDs and/or Node/Tier IDs).

The real time correlation between these two monitoring systems thus enables a rich bidirectional metric sharing environment. That is, the techniques herein provide a messaging system for APM/NPM data correlation in real time, with optional in-band messaging (no additional overhead) which leverages the application communication itself by piggybacking for correlation without changing application behavior. The techniques herein also allow for the presentation of the data to be cross-correlated as well, where “launching in context” functionality allows an admin, post real time, to perform intelligent analysis of the entire systems as a whole, with both the NPM data and APM data at their disposal in an explicitly correlated manner.

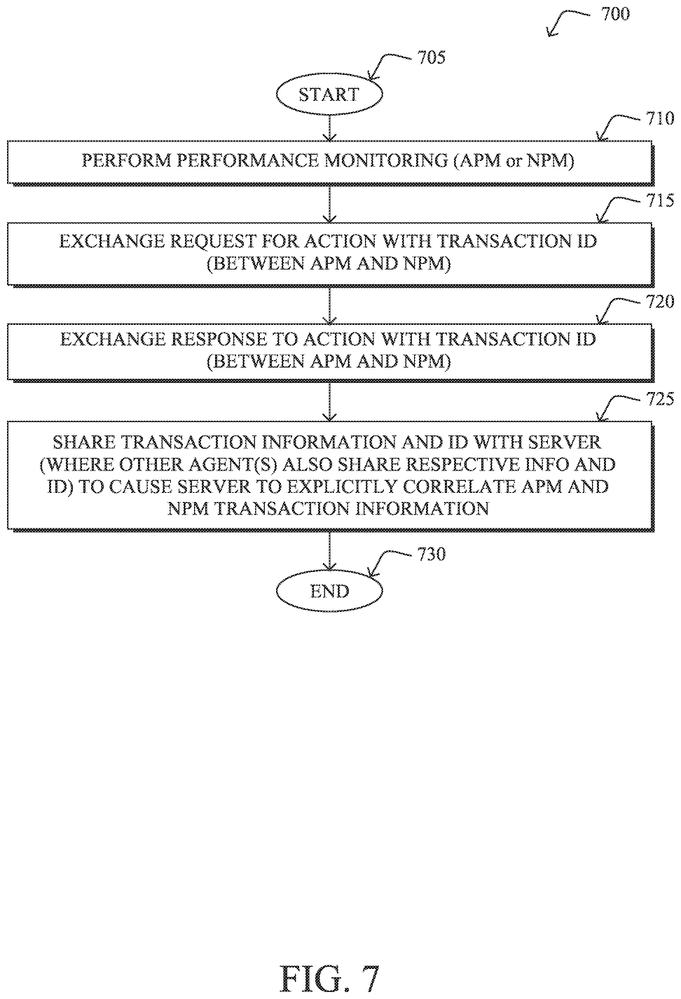

In closing, FIG. 7 illustrates an example simplified procedure for end-to-end (E2E) network and application visibility correlation leveraging integrated inter-system messaging in accordance with one or more embodiments described herein, particularly from the perspective of either an APM or NPM agent. For example, a non-generic, specifically configured device (e.g., device 200, particularly a device with an APM agent and/or NPM agent installed) may perform procedure 700 by executing stored instructions (e.g., process 248, such as an observability agent process). The procedure 700 may start at step 705, and continues to step 710, where, as described in greater detail above, an agent process may perform performance monitoring (e.g., APM or NPM). That is, the agent process may perform performance monitoring according to a first performance monitoring platform, wherein the first performance monitoring platform is one of either a network performance monitoring platform or an application performance monitoring platform.

In step 715, the agent process may exchange a request message with a remote agent process that is performing performance monitoring according to a second performance monitoring platform, wherein the second performance monitoring platform is one of either the network performance monitoring platform or the application performance monitoring platform that is not the first performance monitoring platform, wherein the request message comprises a transaction identifier and a requested action.

Also, in step 720, in response to the request message, the agent process exchanges a response message with the remote agent process, wherein the response message comprises an acknowledgment of the transaction identifier and the requested action.

In step 725, the agent process may then share, based on the requested action, first information associated with the performance monitoring according to the first performance monitoring platform along with the transaction identifier, wherein the remote agent process shares second information associated with the performance monitoring according to the second performance monitoring platform along with the transaction identifier and based on the requested action, the sharing causing explicit correlation of the first information and the second information based on the transaction identifier.

The simplified procedure 700 may then end in step 730, notably with the ability to continue ingesting and sharing data. Other steps may also be included generally within procedure 700. For example, such steps (or, more generally, such additions to steps already specifically illustrated above), may include: correlating, at the agent process, the first information and the second information based on the transaction identifier into correlated information, and sending, from the agent process, the correlated information to a server of the first performance monitoring platform; or else sharing the first information to a server along with the transaction identifier, wherein the remote agent process shares the second information to the server along with the transaction identifier, wherein the server correlates the first information and the second information based on the transaction identifier into correlated information; and so on.

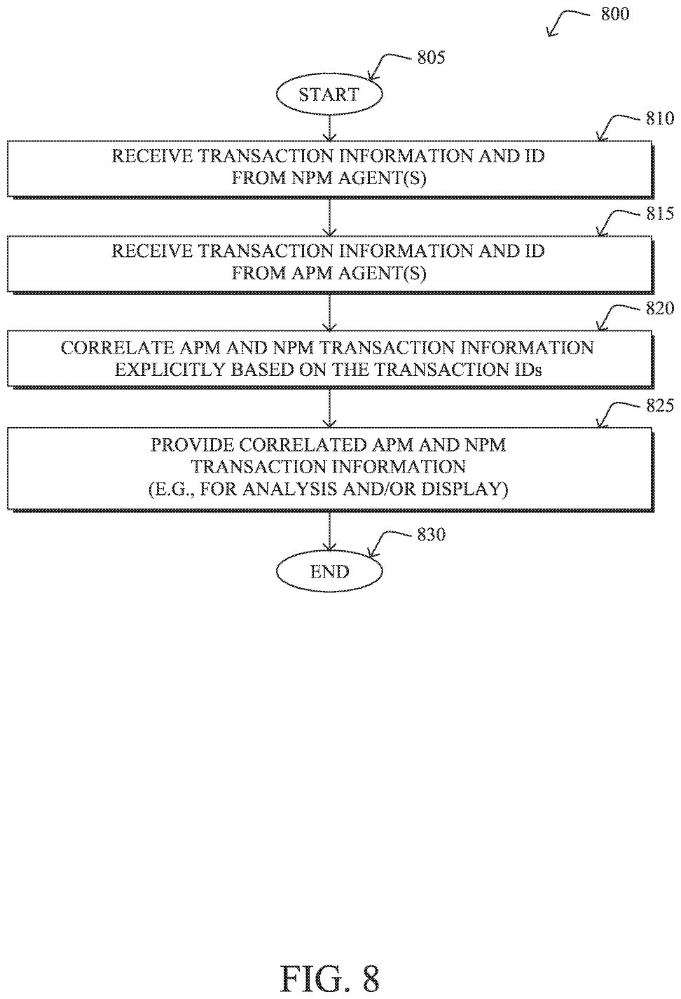

In addition, FIG. 8 illustrates an example simplified procedure for end-to-end (E2E) network and application visibility correlation leveraging integrated inter-system messaging in accordance with one or more embodiments described herein, particularly from the perspective of an observability system server (e.g., an NPM or APM server, or a combined NPM/APM server). For example, a non-generic, specifically configured device (e.g., device 200, particularly a server or controller, aggregator, etc.) may perform procedure 800 by executing stored instructions (e.g., process 248, such as the observability agent process, namely the server-side participation of the agent-based monitoring system herein). The procedure 800 may start at step 805, and continues to step 810, where, as described in greater detail above, a server receives network performance monitoring information (for a “transaction” or time period) from a network agent process configured to perform performance monitoring according to a network performance monitoring platform, the network performance monitoring information having a transaction identifier. Also, in step 815, the server receives application performance monitoring information (for the “transaction” or time period) from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action.

In step 820, the server may then correlate the network performance monitoring information and the application performance monitoring information into correlated information explicitly based on the transaction identifier.

In step 825, therefore, the server may then provide the correlated information as an integration of the network performance monitoring information and the application performance monitoring information (e.g., for analysis and/or display).

The simplified procedure 800 may then end in step 830, notably with the ability to continue receiving and processing (e.g., presenting) transaction information. Other steps may also be included generally within procedure 800. For example, such steps (or, more generally, such additions to steps already specifically illustrated above), may include: providing a graphical user interface with an integrated view of the network performance monitoring information and the application performance monitoring information; and so on.

It should be noted that while certain steps within procedures 700-800 may be optional as described above, the steps shown in FIGS. 7-8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 700-800 are described separately, certain steps from each procedure may be incorporated into each other procedure, and the procedures are not meant to be mutually exclusive.

The techniques described herein, therefore, provide for end-to-end (E2E) network and application visibility correlation leveraging integrated inter-system messaging. In particular, the techniques herein establish a true technical integration platform that provides an integrated view of application and network performance that is correlated, in-band and in real-time. That is, the communication and correlation protocol herein creates a “full duplex” communication between the network performance monitoring tool (e.g., an HTTP Client) and the application performance monitoring tool (e.g., an HTTP Server). Note that while network performance monitoring and application performance monitoring both exist independently, the techniques herein provide the communication protocol necessary to combine the two monitoring systems together explicitly, with full transaction-based application monitoring depth (e.g., at the level of individual transactions). This is specifically opposed to visibility based solely on implicitly correlating such things as user experience or end device perspectives (e.g., poor application performance) with network performance metrics, which occurs after the fact using time/event overlap-based correlation techniques (e.g., when a user indicates a bad communication session experience, traditional techniques may look for network performance during the time window of the user's communication session to look for associated problems).

That is, the techniques herein perform real-time correlation based explicitly on transaction IDs passed between the NPM and APM agents, such that specific network metrics (and problems) may be tied directly to specific application and/or transaction events (and problems). In other words, the techniques herein advantageously remove the guesswork and implied correlation by passing communication messages back and forth between NPM and APM agents to say, essentially, “here is this transaction passing through you now, what are you network metrics right now while processing the transaction right now”, and vice versa.

In still further embodiments of the techniques herein, a business impact of the transaction information can also be quantified. That is, because of issues related to specific applications/processes (e.g., lost traffic, slower servers, overloaded network links, etc.), various corresponding business transactions may have been correspondingly affected for those applications/processes (e.g., online purchases were delayed, page visits were halted before fully loading, user satisfaction or dwell time decreased, etc.), while other processes (e.g., on other network segments or at other times) remain unaffected. The techniques herein, therefore, can correlate the transaction information (e.g., associated network and application metrics) with various business transactions in order to better understand the effect on the business transactions, accordingly.

Illustratively, the techniques described herein may be performed by hardware, software, and/or firmware, such as in accordance with the illustrative observability agent process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, a method herein may comprise: performing, by an agent process, performance monitoring according to a first performance monitoring platform, wherein the first performance monitoring platform is one of either a network performance monitoring platform or an application performance monitoring platform; exchanging, by the agent process, a request message with a remote agent process that is performing performance monitoring according to a second performance monitoring platform, wherein the second performance monitoring platform is one of either the network performance monitoring platform or the application performance monitoring platform that is not the first performance monitoring platform, wherein the request message comprises a transaction identifier and a requested action; exchanging, by the agent process and in response to the request message, a response message with the remote agent process, wherein the response message comprises an acknowledgment of the transaction identifier and the requested action; and sharing, by the agent process and based on the requested action, first information associated with the performance monitoring according to the first performance monitoring platform along with the transaction identifier, wherein the remote agent process is configured to share second information associated with the performance monitoring according to the second performance monitoring platform along with the transaction identifier and based on the requested action, wherein sharing causes explicit correlation of the first information and the second information based on the transaction identifier.

In one embodiment, the request message is initiated by the network performance monitoring platform using a synthetic in-band request message, and wherein the response message is returned by the application performance monitoring platform in a synthetic in-band response message.

In one embodiment, the request message is initiated by the application performance monitoring platform, and wherein the response message is returned by the network performance monitoring platform.

In one embodiment, the correlation of the first information and the second information based on the transaction identifier is caused to provide a graphical user interface with an integrated view of the first information and the second information.

In one embodiment, the response message further comprises an additional requested action for an initiator of the request message.

In one embodiment, the response message further comprises the second information, and sharing comprises: correlating, at the agent process, the first information and the second information based on the transaction identifier into correlated information; and sending, from the agent process, the correlated information to a server of the first performance monitoring platform.

In one embodiment, sharing comprises: sharing the first information to a server along with the transaction identifier, wherein the remote agent process shares the second information to the server along with the transaction identifier, wherein the server correlates the first information and the second information based on the transaction identifier into correlated information.

In one embodiment, the request message is initiated based on a trigger selected from a group consisting of: a periodic trigger; a policy-based trigger; an error detection; a service level agreement violation; a real-time user-experience-based trigger; and a post-real-time user-experience-based trigger.

In one embodiment, the requested action is selected from a group consisting of: a snapshot request for a complete instance of a transaction; an escalation request to toggle one or more performance monitoring functions; an information request for specified application performance monitoring information; and an information request for specified network performance monitoring information.

In one embodiment, the agent process performs performance monitoring according to the application performance monitoring platform, and wherein the agent process is selected from a group consisting of: an End-User Monitoring (EUM) agent; an application agent; a Remote-user Monitoring (RUM) agent; and a machine agent.

In one embodiment, one of the first information and second information comprises application performance monitoring information selected from a group consisting of: average response time; business transaction information; error rate; and transaction traces.

In one embodiment, the agent process performs performance monitoring according to the network performance monitoring platform, and wherein the agent process is selected from a group consisting of: a browser End-User Monitoring (EUM) agent, an endpoint agent; and a network device agent.

In one embodiment, one of the first information and second information comprises network performance monitoring information selected from a group consisting of: internet path; connectivity; response time; uptime; and throughput.

According to the embodiments herein, another method herein may comprise: receiving, at a server, network performance monitoring information from a network agent process configured to perform performance monitoring according to a network performance monitoring platform, the network performance monitoring information having a transaction identifier; receiving, at the server, application performance monitoring information from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action; correlating, by the server, the network performance monitoring information and the application performance monitoring information into correlated information explicitly based on the transaction identifier; and providing, by the server, the correlated information as an integration of the network performance monitoring information and the application performance monitoring information.

In one embodiment of this method, the request message is initiated by the network performance monitoring platform using a synthetic in-band request message, and wherein the response message is returned by the application performance monitoring platform in a synthetic in-band response message.

In one embodiment of this method, the request message is initiated by the application performance monitoring platform, and wherein the response message is returned by the network performance monitoring platform.

According to the embodiments herein, a system herein may comprise: a server; a network agent process configured to perform performance monitoring according to a network performance monitoring platform; and an application agent process configured to perform performance monitoring according to an application performance monitoring platform; wherein the network agent process and application agent process are configured to exchange a request message comprising a transaction identifier and a requested action and, in response to the request message, to exchange a response message comprising an acknowledgment of the transaction identifier and the requested action; wherein the network agent process is further configured to share network performance monitoring information to the server along with the transaction identifier and based on the requested action, and wherein the application agent process is further configured to share application performance monitoring information to the server along with the transaction identifier and based on the requested action; wherein the server explicitly correlates the network performance monitoring information and the application performance monitoring information based on the transaction identifier into correlated information.

In one embodiment of this system, the request message is initiated by the network performance monitoring platform using a synthetic in-band request message, and wherein the response message is returned by the application performance monitoring platform in a synthetic in-band response message.

In one embodiment of this system, the request message is initiated by the application performance monitoring platform, and wherein the response message is returned by the network performance monitoring platform.

In one embodiment of this system, the server is further configured to provide a graphical user interface with an integrated view of the network performance monitoring information and the application performance monitoring information

Additionally, according to the embodiments herein, a tangible, non-transitory, computer-readable medium herein may have computer-executable instructions stored thereon that, when executed by a processor on a computer, may cause the computer to perform a method comprising: performing, as an agent process, performance monitoring according to a first performance monitoring platform, wherein the first performance monitoring platform is one of either a network performance monitoring platform or an application performance monitoring platform; exchanging, by the agent process, a request message with a remote agent process that is performing performance monitoring according to a second performance monitoring platform, wherein the second performance monitoring platform is one of either the network performance monitoring platform or the application performance monitoring platform that is not the first performance monitoring platform, wherein the request message comprises a transaction identifier and a requested action; exchanging, by the agent process and in response to the request message, a response message with the remote agent process, wherein the response message comprises an acknowledgment of the transaction identifier and the requested action; and sharing, by the agent process and based on the requested action, first information associated with the performance monitoring according to the first performance monitoring platform along with the transaction identifier, wherein the remote agent process is configured to share second information associated with the performance monitoring according to the second performance monitoring platform along with the transaction identifier and based on the requested action, wherein sharing causes explicit correlation of the first information and the second information based on the transaction identifier.

Further, according to the embodiments herein an apparatus herein may comprise: one or more network interfaces to communicate with a network; a processor coupled to the network interfaces and configured to execute one or more processes; and a memory configured to store an agent process executable by the processor, the process, when executed, configured to: perform performance monitoring according to a first performance monitoring platform, wherein the first performance monitoring platform is one of either a network performance monitoring platform or an application performance monitoring platform; exchange a request message with a remote agent process that is performing performance monitoring according to a second performance monitoring platform, wherein the second performance monitoring platform is one of either the network performance monitoring platform or the application performance monitoring platform that is not the first performance monitoring platform, wherein the request message comprises a transaction identifier and a requested action; exchange, in response to the request message, a response message with the remote agent process, wherein the response message comprises an acknowledgment of the transaction identifier and the requested action; and share, based on the requested action, first information associated with the performance monitoring according to the first performance monitoring platform along with the transaction identifier, wherein the remote agent process is configured to share second information associated with the performance monitoring according to the second performance monitoring platform along with the transaction identifier and based on the requested action, wherein sharing causes explicit correlation of the first information and the second information based on the transaction identifier.

Moreover, according to the embodiments herein, another tangible, non-transitory, computer-readable medium herein may have computer-executable instructions stored thereon that, when executed by a processor on a computer, may cause the computer to perform a method comprising: receiving, as a server, network performance monitoring information from a network agent process configured to perform performance monitoring according to a network performance monitoring platform, the network performance monitoring information having a transaction identifier; receiving, at the server, application performance monitoring information from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action; correlating, by the server, the network performance monitoring information and the application performance monitoring information into correlated information explicitly based on the transaction identifier; and providing, by the server, the correlated information as an integration of the network performance monitoring information and the application performance monitoring information.

Still further, according to the embodiments herein an apparatus herein may comprise: one or more network interfaces to communicate with a network; a processor coupled to the network interfaces and configured to execute one or more processes; and a memory configured to store a server process that is executable by the processor, the process, when executed, configured to: receive network performance monitoring information from a network agent process configured to perform performance monitoring according to a network performance monitoring platform, the network performance monitoring information having a transaction identifier; receive application performance monitoring information from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action; correlate the network performance monitoring information and the application performance monitoring information into correlated information explicitly based on the transaction identifier; and provide the correlated information as an integration of the network performance monitoring information and the application performance monitoring information.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
performing, by an agent process, performance monitoring according to a first performance monitoring platform, wherein the first performance monitoring platform is one of either a network performance monitoring platform or an application performance monitoring platform;
exchanging, by the agent process, a request message with a remote agent process that is performing performance monitoring according to a second performance monitoring platform, wherein the second performance monitoring platform is the other one of either the network performance monitoring platform or the application performance monitoring platform, wherein the request message comprises a transaction identifier and a requested action;
exchanging, by the agent process and in response to the request message, a response message with the remote agent process, wherein the response message comprises an acknowledgment of the transaction identifier and the requested action; and
sharing, by the agent process and based on the requested action, first information associated with the performance monitoring according to the first performance monitoring platform along with the transaction identifier, wherein the remote agent process is configured to share second information associated with the performance monitoring according to the second performance monitoring platform along with the transaction identifier and based on the requested action, wherein sharing causes explicit correlation of the first information and the second information based on the transaction identifier.

2. The method as in claim 1, wherein the request message is initiated by the network performance monitoring platform using a synthetic in-band request message, and wherein the response message is returned by the application performance monitoring platform in a synthetic in-band response message.

3. The method as in claim 1, wherein the request message is initiated by the application performance monitoring platform, and wherein the response message is returned by the network performance monitoring platform.

4. The method as in claim 1, wherein the explicit correlation of the first information and the second information based on the transaction identifier is caused to provide a graphical user interface with an integrated view of the first information and the second information.

5. The method as in claim 1, wherein the response message further comprises an additional requested action for an initiator of the request message.

6. The method as in claim 1, wherein the response message further comprises the second information, and wherein sharing comprises:
correlating, at the agent process, the first information and the second information based on the transaction identifier into correlated information; and
sending, from the agent process, the correlated information to a server of the first performance monitoring platform.

7. The method as in claim 1, wherein sharing comprises:
sharing the first information to a server along with the transaction identifier, wherein the remote agent process shares the second information to the server along with the transaction identifier, wherein the server correlates the first information and the second information based on the transaction identifier into correlated information.

8. The method as in claim 1, wherein the request message is initiated based on a trigger selected from a group consisting of: a periodic trigger; a policy-based trigger; an error detection; a service level agreement violation; a real-time user-experience-based trigger; and a post-real-time user-experience-based trigger.

9. The method as in claim 1, wherein the requested action is selected from a group consisting of: a snapshot request for a complete instance of a transaction; an escalation request to toggle one or more performance monitoring functions; an information request for specified application performance monitoring information; and an information request for specified network performance monitoring information.

10. The method as in claim 1, wherein the agent process performs performance monitoring according to the application performance monitoring platform, and wherein the agent process is selected from a group consisting of: an End-User Monitoring (EUM) agent; an application agent; a Remote-user Monitoring (RUM) agent; and a machine agent.

11. The method as in claim 1, wherein one of the first information and second information comprises application performance monitoring information selected from a group consisting of: average response time; business transaction information; error rate; and transaction traces.

12. The method as in claim 1, wherein the agent process performs performance monitoring according to the network performance monitoring platform, and wherein the agent process is selected from a group consisting of: a browser End-User Monitoring (EUM) agent, an endpoint agent; and a network device agent.

13. The method as in claim 1, wherein the network performance monitoring platform is configured to report metrics related to performance of a network, and the application performance monitoring platform is configured to report metrics related to performance of an application.

14. A method, comprising:
receiving, at a server, network performance monitoring information from a network agent process configured to perform performance monitoring according to a network performance monitoring platform, the network performance monitoring information having a transaction identifier;
receiving, at the server, application performance monitoring information from an application agent process configured to perform performance monitoring according to an application performance monitoring platform, the application performance monitoring information having the transaction identifier, wherein the network agent process and application agent process are configured to exchange a request message comprising the transaction identifier and a requested action and, in response to the request message, to exchange a response message comprising an acknowledgment of the transaction identifier and the requested action;
correlating, by the server, the network performance monitoring information and the application performance monitoring information into correlated information explicitly based on the transaction identifier; and
providing, by the server, the correlated information as an integration of the network performance monitoring information and the application performance monitoring information.

15. The method as in claim 14, wherein the request message is initiated by the network performance monitoring platform using a synthetic in-band request message, and wherein the response message is returned by the application performance monitoring platform in a synthetic in-band response message.

16. The method as in claim 14, wherein the request message is initiated by the application performance monitoring platform, and wherein the response message is returned by the network performance monitoring platform.

17. A system, comprising:
a server;
a first device executing a network agent process configured to perform performance monitoring according to a network performance monitoring platform; and
a second device executing an application agent process configured to perform performance monitoring according to an application performance monitoring platform,
wherein the network agent process and application agent process are configured to exchange a request message comprising a transaction identifier and a requested action and, in response to the request message, to exchange a response message comprising an acknowledgment of the transaction identifier and the requested action, further wherein the network agent process is further configured to share network performance monitoring information to the server along with the transaction identifier and based on the requested action, and wherein the application agent process is further configured to share application performance monitoring information to the server along with the transaction identifier and based on the requested action, and further wherein the server explicitly correlates the network performance monitoring information and the application performance monitoring information based on the transaction identifier into correlated information.

18. The system as in claim 17, wherein the request message is initiated by the network performance monitoring platform using a synthetic in-band request message, and wherein the response message is returned by the application performance monitoring platform in a synthetic in-band response message.

19. The system as in claim 17, wherein the request message is initiated by the application performance monitoring platform, and wherein the response message is returned by the network performance monitoring platform.

20. The system as in claim 17, wherein the server is further configured to provide a graphical user interface with an integrated view of the network performance monitoring information and the application performance monitoring information.
